(19) United States
(12) Patent Application Publication
(10) Pub. No.: US 2003/0143449 A1
(43) Pub. Date: Jul. 31, 2003

(54) Fuel cell with an improved effeciency for generating electric power

(76) Inventor: Rudolf Hunik, Oosterbeek (NL)

Correspondence Address: BANNER & WITCOFF, 1001 G STREET N W, SUITE 1100, WASHINGTON, DC, 20001, US

(21) Appl. No.: 10/220,695

(22) PCT Filed: Mar. 8, 2001
(86) PCT No.: PCT/NL01/00193

(30) Foreign Application Priority Data
Mar. 8, 2000 (NL) 1014585

(51) Int. Cl. H01M 8/04

(52) U.S. Cl. 429/34; 429/26

(57) ABSTRACT

A device for generating electric power by means of a fuel cell, comprising: a fuel supply connection (2) for supplying substantially gasous fuel to the fuel cell (1); an air supply (3) connection for supplying to the fuel cell a gas which is at least partially formed by oxygen; an air discharge (4) connection for discharging from the fuel cell the part of the gas which is supplied via the air supply connection and not used in the fuel cell, and an outlet connection (5) for discharging from the fuel cell the reaction products of the fuel cell, wherein the device comprises: a separating device (9, 11) connected to the outlet connection of the fuel cell for separating the combustible gases from the gases supplied via the outlet connection; and a supply device for supplying to the fuel supply connection the combustible gases coming from the separating device. These measures have the result that particularly the combustible gases which are present in a low concentration at the end of the fuel cell are “reprocessed” into gases with a higher concentration of such combustible gases, so that they can be fed back to the beginning of the fuel cell together with “fresh” fuel.

The present invention relates to a device for generating electric power by means of a fuel cell, comprising:

a fuel supply connection for supplying substantially gaseous fuel to the fuel cell;

an air supply connection for supplying to the fuel cell a gas which is at least partially formed by oxygen;

an air discharge connection for discharging from the fuel cell the part of the gas which is supplied via the air supply connection and not used in the fuel cell; and

an outlet connection for discharging from the fuel cell the reaction products of the fuel cell.

Such a device is known from the international patent application with publication number WO-A-99/10945.

This prior art device for generating electric power comprises a fuel cell, wherein a reaction chamber is connected to the air discharge connection of the fuel cell and the outlet connection of the fuel cell. This reaction chamber comprises two different spaces which are separated by a ceramic material with an electrolyte arranged thereon. With this electrolyte it is possible to bring about an exothermic reaction between the combustible reaction products of the fuel cell and the unused part of the air by means of oxygen transport through the electrolyte. This chamber then uses a greater part of the chemical energy still stored in the fuel gases for generating heat.

It is pointed out here that owing to the properties of a fuel cell it is not economically attractive to use these gases efficiently inside the fuel cell itself; minimal concentrations of fuel gases respectively oxygen are necessary in the relevant parts of the fuel cell to these gases efficiently inside the fuel cell itself; minimal concentrations of fuel gases respectively oxygen are necessary in the relevant parts of the fuel cell to enable effective operation. When, as seen in the flow direction of the fuel cell, these concentrations are no longer achieved, a fuel cell no longer operates in economically efficient manner.

According to the prior art the chemical energy of the fuels is still used by causing other reactions to be performed in the reaction chamber where no electricity is generated. Heat is herein generated.

The object of such a device is generally to generate electric power with the greatest possible efficiency. Although the generation of heat does increase the efficiency, the increase in efficiency is greater when the conversion to electric power takes place directly in the fuel cell; in the case of conversion to heat a subsequent conversion to electric power must after all still take place, which once again reduces the efficiency.

Known from U.S. Pat. No. 5,079,103 is a device for generating electric power by means of a fuel cell, which is provided with a solid substance as electrolyte, which device comprises:

a fuel supply connection for supplying substantially gaseous fuel to the fuel cell;

an air supply connection for supplying to the fuel cell a gas which is at least partially formed by oxygen;

an air discharge connection for discharging from the fuel cell the part of the gas which is supplied via the air supply connection and not used in the fuel cell; and

an outlet connection for discharging from the fuel cell the reaction products of the fuel cell,

wherein the device comprises:

a separating device connected to the outlet connection of the fuel cell for separating the combustible gases from the gases supplied via the outlet connection; and

a supply device for supplying to the fuel supply connection the combustible gases coming from the separating device.

In this prior art device the H₂ gas is separated in a single step from the gases coming from the outlet connection of the fuel cell. Use is made for this purpose of a single process, from which there results H₂ on the one hand and residual gases on the other.

The residual gas, which is a mixture of among other things H₂O, CO₂ and inert gases, must be discharged. With a view to the increasing emission of CO₂, improvement in respect of the separation of CO₂ is desired.

The object of the present invention is to provide an improved device wherein the residual gases become available in sorted manner so that they can each be individually discharged or utilized in responsible manner.

This object is achieved in that the separating device comprises a first separator connecting onto the outlet connection of the fuel cell for separating substantially only water from the gases coming from the outlet connection.

The exhaust gases of a fuel cell of the above stated type substantially comprise H₂, H₂O, CO₂, CO and a small quantity of inert gases.

In the prior art separation of H₂ there remains a mixture with large concentrations of H₂O and CO₂. In respect of the wish to limit the emission of CO₂ it is highly undesirable to allow this gas mixture to escape into the air. The invention provides for the separation of H₂O and CO₂ in separate steps, so that both substances become available separately and can be individually further processed in the most optimal manner. A further advantage is that both separating processes can be individually optimized.

Another advantage is that the water can be recovered. There is after all a shortage of pure water throughout the world. The recovered quantities of water are of course not particularly large, but the water can be of a high quality, so that it can be used as boiler feed water, spray water for cooling in compression or the like.

According to a further preferred embodiment the first separator comprises a condenser for separating water by means of condensation from the gases coming from the fuel cell.

This configuration makes use of per se known art, so that a reliable device for separating water is obtained.

According to an alternative embodiment the first separator comprises a membrane for separating water from the gases coming from the fuel cell. Such a device is described in the Netherlands patent number 1011626.

This configuration makes use of an alternative embodiment, wherein a more modern, and perhaps cheaper and more effective technology is applied.

Furthermore, water of a high purity is hereby also obtained, so that it can for instance be used as feed water for inlet air coolers or for boilers.

According to a further preferred embodiment the separating device comprises a second separator connected downstream of the first separator, for separating combustible gases from the gases coming from the first separator. After the removal of water there remains a mixture of combustible gases, such as CO, H₂ and perhaps also a small residue with the original fuel, such as CH₄, and a quantity of non-combustible gases, such as CO₂, inert gases possibly present in the fuel and residual gases.

The actual enrichment process therefore takes place in the second separator to reprocess the combustible gases once again to a concentration suitable for the fuel cell.

Although other configurations are not precluded, the second separator preferably comprises a condenser for separating CO₂ by means of condensation from the gases coming from the fuel cell, and a compressor is preferably placed between the first separator and the second separator.

A total separation is hereby obtained between H₂O, CO₂ and a mixture of combustible gases, inert gases and residual gases.

As stated above, the non-combustible gases from the second separator consist substantially of CO₂ and possibly a limited quantity of inert gases and residual gases. In order to reduce the emission of CO₂ it is attractive to supply the gases in question to a storage reservoir.

As stated above, the non-combustible residual gases consist of CO₂, a number of inert gases and residual gases such as N₂. In view of the high price of inert gases, it may be economically attractive to separate these from the gas stream exiting the fuel cell.

For this purpose a third separator is preferably placed in the circuit between the output connection of the fuel cell and the fuel supply connection of the fuel cell for separating possible residual gases, such as inert gases, from the gas flowing in the circuit.

For a further increase in the thermal efficiency of the whole device, heat exchangers are incorporated in the circuit for transferring heat to other gas streams circulating in the device so as to thus increase the electrical or thermal efficiency of the device.

Preferably placed between the CO₂-compressor and the storage reservoir is a heat exchanger, the other side of which is connected to the teed line for fuel to the fuel cell. Heat exchange hereby takes place with the fuel supplied to the fuel cell via the feed line (optionally an expansion of this fuel). This is found to be a particularly effective manner of increasing the efficiency of the whole device.

The present invention will be elucidated hereinbelow with reference to the annexed drawings, in which:

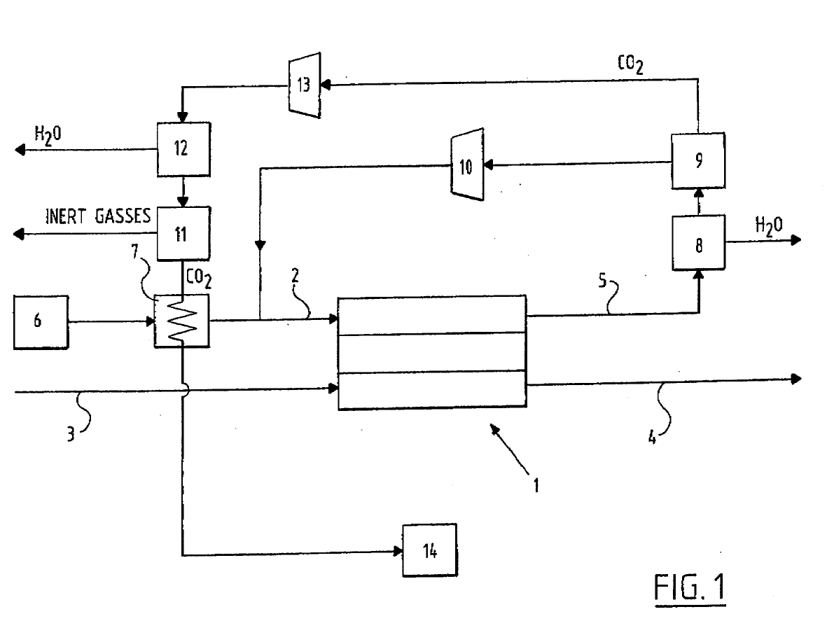

FIG. 1 shows a diagram of a first embodiment of a device according to the invention; and

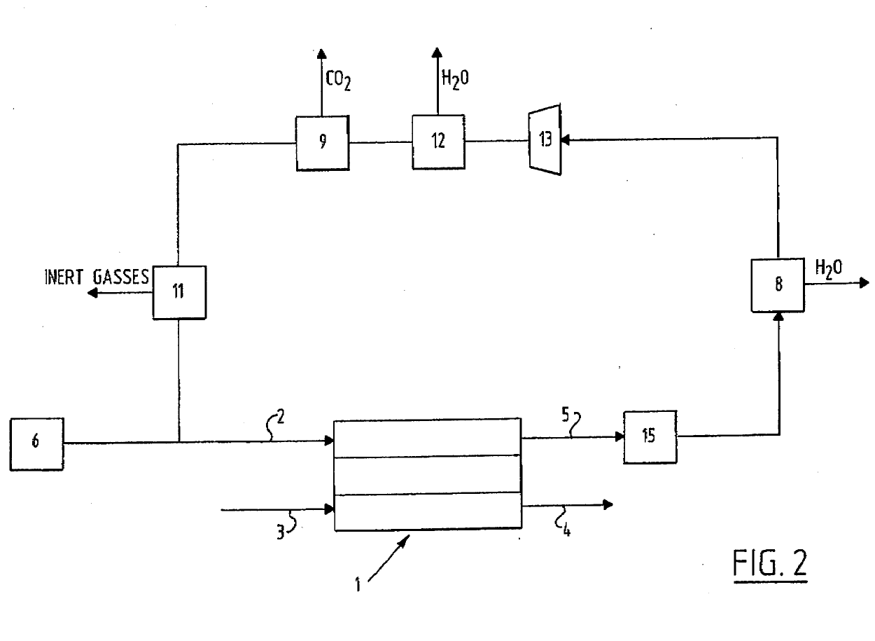

FIG. 2 shows a diagram of a second embodiment of a device according to the invention.

The device shown in FIG. 1 comprises a fuel cell designated as a whole with “1”. The fuel cell is provided with a fuel supply connection 2 for supplying substantially gaseous fuel to the fuel cell, an air supply connection 3 for supplying to the fuel cell a gas at least partially formed by oxygen, an air discharge connection 4 for discharging from the fuel cell the part of the gas which is supplied via the air supply connection and not used in the fuel cell, and an outlet connection 5 for discharging from the fuel cell the reaction products of the fuel cell.

The device further comprises a gas source 6, which can for instance be formed by a connection to the gas mains. Gas source 6 is connected via a heat exchanger 7 to fuel supply connection 2.

Air supply connection 3 is connected to a suction device for air (not shown in the drawing), for instance in the form of a compressor.

With interposing of an optional cleaning device (not shown in the drawing) the air discharge connection 4 is connected to the environment, optionally via a turbine.

A first separator 8 is connected to outlet connection 5 of fuel cell 1. The first separator 8 is adapted to separate water from the exhaust gases of the fuel cell. The first separator can take the form of a membrane separator or a condenser.

A second separator 9 is connected to first separator 8. Second separator 9 is adapted to make a separation between the combustible constituents of the exhaust gas and the non-combustible constituents. The combustible constituents are supplied via a compressor 10 to fuel supply connection 2 of fuel cell 1. This is the characterizing measure of the present invention; by increasing the concentration of combustible gas constituents and supplying these to the fuel cell a greater part of the fuel can be used for direct generation of electricity. The efficiency of the conversion of chemical energy into electric power is hereby increased greatly.

The second separator 9 is for instance formed by a membrane separator.

The non-combustible gases of second separator 9 are then supplied to a compressor 13. The gas substantially formed by CO₂ is supplied to a fourth separator 12 after compression by compressor 13. The fourth separator 12 removes a final quantity of water, which is not completely removed in first separator 8 from the gas consisting substantially of CO₂, and thereby increases the quality of the CO₂ to be transported in liquid form.

The gas consisting substantially of CO₂ flowing out of the fourth separator 12, after cooling in inter alia heat exchanger 7, whereby condensation of CO₂ occurs, is then supplied via a transport means to a storage tank which is for instance formed by an underground gas storage space. Usually used for this purpose are spaces which become available owing to the extraction of combustible natural gas from such a space.

It is finally noted that it is possible to make diverse changes to the diagram shown here; it is thus possible for instance to place a third separator 11 for separating inert gases between outlet connection 5 and the first separator 8 for water, or to place this between first separator 8 and second separator 9. The inert gases can herein be recovered. This is economically attractive in many cases. It is mainly a question of temperature or dimensioning which determines where said third separator 11 can best be placed.

A similar consideration also applies for the second separator 9. This can also be placed at a different location between outlet connection 5 and storage tank 14.

FIG. 2 shows a slightly different configuration of a device according to the invention.

Outlet connection 5 of the fuel cell is herein connected to a so-called shifter 15. This shifter contains a catalyst which converts CO possibly present in the exhaust gases of the fuel cell into CO₂ and H₂. A greater effectiveness of the total device is hereby obtained because the chemical energy still present in CO can be used efficiently. Such a “shifter” can otherwise also be applied in the embodiment shown in FIG. 1.

The outlet connection of this shifter is connected to the first separator 8 for separating H₂O already present in the previous embodiment.

The remaining gas mixture, which comprises H₂, CO₂ and a small quantity of H₂O, is fed to a compressor 13. The function of the two compressors 10 and 13 of the previous embodiment is hereby combined.

The compressed gas coming from this compressor 13 is supplied to a fourth separator 12 for separating still remaining H₂O. Use is preferably made for this purpose of a so-called “condicyclone” as described in the international patent application with publication number WO 00/40834.

Following on herefrom is a second separator 9 for separating CO₂. Since the gas is compressed, use can be made in attractive manner of a condensation separator for separating CO₂.

Finally, the resulting H₂ is separated in a third separator 11 for separating inert gases. Because it has been compressed by compressor 13, the resulting H₂ has sufficient pressure to be fed to fuel supply connection 2 of fuel cell 1. It is otherwise possible for other residual gases such as N₂ to be present in the circulating gas mixture besides possible inert gases. It is therefore possible to add a separating device geared to the type of gas in question to the separating device for inert gases.

It is pointed out that the invention can be applied to fuel cells which have a solid substance as electrolyte, such as SOFC-cells and PEM-cells.

It is otherwise by no means essential for the present invention that the remaining CO₂ be stored. This is merely an additional attractive embodiment which is intended for the purpose of reducing the CO₂ emission.

It is further possible to apply compressors, pumps and heat exchangers at diverse other locations in the above diagram.

1. Device for generating electric power by means of a fuel cell, which is provided with a solid substance as electrolyte and which comprises:
a fuel supply connection for supplying substantially gaseous fuel to the fuel cell;
an air supply connection for supplying to the fuel cell a gas which is at least partially formed by oxygen;
an air discharge connection for discharging from the fuel cell the part of the gas which is supplied via the air supply connection and not used in the fuel cell; and
an outlet connection for discharging from the fuel cell the reaction products of the fuel cell,
wherein the device comprises:
a separating device connected to the outlet connection of the fuel cell for separating the combustible gases from the gases supplied via the outlet connection; and
a supply device for supplying to the fuel supply connection the combustible gases coming from the separating device, wherein the separating device comprises a first separator connecting onto the outlet connection of the fuel cell for separating substantially only water from the gases coming from the outlet connection, wherein the separating device comprises a second separator connected downstream of the first separator for separating CO₂ from the gases coming from the fuel cell, characterized in that the second separator comprises a condenser for separating CO₂ by means of condensation from the gases coming from the fuel cell, and that a compressor is placed between the first separator and the second separator.

2. Device as claimed in claim 1, characterized in that the first separator comprises a condenser for separating water by means of condensation from the gases coming from the fuel cell.

3. Device as claimed in claim 1, characterized in that the first separator comprises a membrane for separating water from the gases coming from the fuel cell.

4. Device as claimed in any of the foregoing claims, characterized in that downstream of the outlet connection of the fuel cell are arranged catalysts for enhancing the conversion of CO and H₂O into H₂ and CO₂.

5. Device as claimed in one of the claims 1-4, characterized in that the outlet connection of the second separator for CO₂ is connected to a storage reservoir.

6. Device as claimed in any of the foregoing claims, characterized in that a third separator is placed in the circuit between the output connection of the fuel cell and the fuel supply connection of the fuel cell for separating possible residual gases, such as inert gases, from the gas flowing in the circuit.

7. Device as claimed in claim 6, characterized in that the third separator is placed between the second separator and the fuel supply connection of the fuel cell.

8. Device as claimed in any of the foregoing claims, characterized in that a fourth separator for separating water residues from the gas flowing in the circuit is placed in the circuit between the outlet connection of the fuel cell and the fuel supply connection of the fuel cell.

9. Device as claimed in any of the foregoing claims, characterized in that heat exchangers are incorporated in the circuit for transferring heat to gas streams circulating in the device so as to thus increase the-electrical or thermal efficiency of the device.

10. Device as claimed in any of the claims 6-9, characterized in that the second separator is thermally connected to a heat exchanger, the other side of which is connected to the feed line for fuel to the fuel cell.
